(19) United States
(12) Patent Application Publication
(10) Pub. No.: US 2022/0396902 A1
(43) Pub. Date: Dec. 15, 2022

(54) MANUFACTURED NATURAL SHEARLING MATERIAL

(71) Applicant: R G BARRY CORPORATION, Pickerington, OH (US)

(72) Inventors: Lee F. SMITH, Pickerington, OH (US); Andrew E. GREVER, Columbus, OH (US)

(73) Assignee: R G BARRY CORPORATION, Pickerington, OH (US)

(21) Appl. No.: 17/838,871

(22) Filed: Jun. 13, 2022

Related U.S. Application Data
(60) Provisional application No. 63/209,637, filed on Jun. 11, 2021.

(51) Int. Cl. D04B 1/14; D06N 3/00

(52) U.S. Cl. CPC D04B 1/14; D06N 3/0011; D06N 3/0036; D10B 2211/02; D06N 2211/28; D06N 2201/06

(57) ABSTRACT

A manufactured shearling material comprises a leather layer and a knitted wool layer laminated together. The leather layer may be made by grinding up waste/scrap leather and adhering it to a backing, and giving texture (or texturizing) a surface to give the surface a particular feel (e.g., a suede feel). The scrap leather may be from various animals, including cows, sheep, etc. The knitted wool layer may comprise recycled wool clippings organized together to simulate the fur surface of natural shearling, and the wool clippings may be combined with one or more additional materials (e.g., fur, cotton, polyester, Tencel, silk, etc.) at various blends (e.g., 80/20 blend of wool and Tencel) to control the feel, aesthetics, and/or functionality, etc. of the knitted wool layer. Furs, hair, or other materials other may be utilized instead of the recycled wool clippings. An additional layer may be provided on top of the leather, with such additional layer being a synthetic recycled fabric.

### CROSS-REFERENCE TO RELATED APPLICATIONS

This application claims the benefit of U.S. Provisional Patent Application No. 63/209,637 filed on Jun. 11, 2021, the contents of which are incorporated herein by reference in their entirety.

### BACKGROUND

Shearling is a treated animal skin or pelt with the wool having been left on it. Shearling may thus comprise a suede surface on one side and a fur or wool covered surface on the other, opposite side. The suede surface of the shearling is often times treated or tanned, and the wool or fur on the opposite side may be clipped or trimmed as may be desirable and forms a natural fleece material. Such natural fleece is an excellent insulator and very soft in touch and, therefore, often used in a variety of products, such as footwear, coats, gloves, hats, etc. In such end use applications, the suede or leather side faces outward (or away from the user), whereas the fleece side faces inward (or in contact with the end user).

Real or natural shearling is expensive in view of the ever increasing demand for shearling products. In addition, real or natural shearling is an animal-based product that is not sustainable. Thus, synthetic or fake shearling has been developed such that end use products utilizing shearling may be more affordable and sustainable for end users. Nevertheless, real or natural shearling has many advantages over synthetic or fake shearling. For example, real or natural shearling breathes better, tends to be more flexible, much heavier in weight, and the fur is much denser than synthetic or fake shearling. Real or natural shearling is also smoother to the touch than synthetic shearling. In addition, synthetic shearling may have a sheen to its outer facing surface, such that third party observers may readily identify it as a fake or synthetic shearling product, whereas the outer hide side of natural or real shearling tends to be dull and a bit tacky to the touch. Accordingly, a need exists for a shearling material that replicates the desirable qualities of natural or real shearling that is sustainable and cost effective.

### SUMMARY

Disclosed herein is a shearling material, comprising recycled leather particles formed together to define a cohesive leather layer having a first surface and a second surface opposite the first surface; and a layer of knitted wool provided on the first face. In some embodiments, the layer of knitted wool includes a plurality of wool clippings knitted to a backing layer. In even further embodiments, the wool clippings extend from a first side of the backing layer and the backing layer includes a second side opposite the first side, and wherein a face of the cohesive leather layer is adhered to the second side of the backing layer after the wool clippings have been knitted thereon. In some embodiments, the wool clippings extend from a first side of the backing layer and the backing layer includes a second side opposite the first side, and wherein the recycled leather particles are provided on the opposite first side of the backing layer and secured together on the backing layer via a binder. In some embodiments, the wool clippings extend from a first side of the backing layer and the backing layer includes a second side opposite the first side attachable to a face of the cohesive leather layer, the cohesive leather layer having an exposed surface opposite the knitted wool layer that is texturized or worked to have a natural feel. In some embodiments, the wool clippings extend from a first side of the backing layer and the backing layer includes a second side opposite the first side attachable to a face of the cohesive leather layer, the cohesive leather layer having an exposed surface on which an outer layer is provided, the outer layer having an outer surface that is texturized or worked to have a natural feel. In some embodiments, the recycled leather particles are provided on a backing layer and secured together on the backing layer via a binder, thereby defining the cohesive leather layer. In some embodiments, the layer of knitted wool includes a plurality of wool clippings knitted to the cohesive leather layer. In some embodiments, the wool clippings extend from a side of the backing layer opposite from the recycled leather particles. In some embodiments, a side of the cohesive leather layer opposite from the backing layer is texturized or worked to have a natural feel. In some embodiments, the wool clippings extend from a side of the cohesive leather layer opposite from the backing layer. In some embodiments, an exposed surface of the backing layer is texturized or worked to have a natural feel. In some embodiments, an outer layer is provided on an exposed surface of the backing layer, the outer layer having an outer surface that is texturized or worked to have a natural feel. Also described herein is a method of producing a shearling material, comprising: forming a cohesive leather layer; and knitting wool clippings to the cohesive leather layer. In some embodiments, forming a cohesive leather layer includes grinding leather into a particulate

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a side view of an example manufactured and natural shearling material that may incorporate the principles of the present disclosure.

FIG. 2 is an exploded view of a manufactured and natural shearling material that may incorporate the principles of the present disclosure.

FIG. 3 is an example method of producing the shearling material.

### DETAILED DESCRIPTION

The present disclosure is related to shearling material and, more particularly, a manufactured shearling material and methods of manufacturing the same.

The embodiments described herein provide a manufactured shearling material. Other embodiments herein provide a method or process for manufacturing the manufactured shearling material.

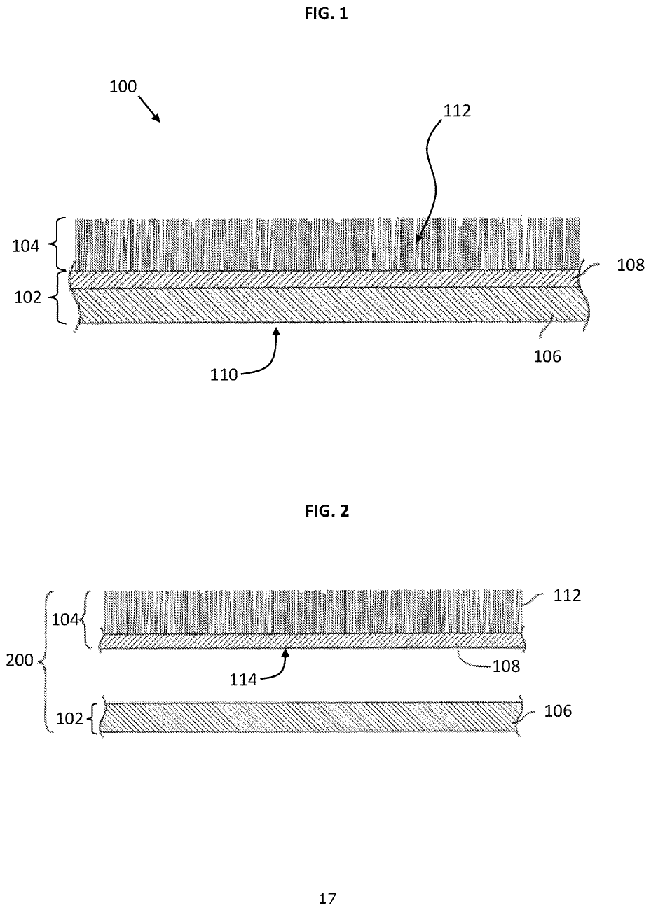

FIG. 1 illustrates a manufactured shearling material 100, according to one or more embodiments of the present disclosure. The depicted manufactured shearling material 100 (hereinafter, the shearling 100) is just one example manufactured shearling material that can suitably incorporate the principles of the present disclosure. Indeed, many alternative designs and configurations of the shearling 100 may be employed, without departing from the scope of this disclosure.

As illustrated, the shearling 100 includes a leather layer 102 and a knitted wool layer 104. The leather layer 102 may include a layer of recycled material 106 and a backing layer 108. For example, the layer of recycled material 106 may be formed by grinding up or shredding waste or scrap leather (or other material) and then adhering the ground/shredded material 106 to the backing layer 108. The backing layer 108 may be a polyester non-woven material, other types of fabric, recycled leather, or other types of material. The binding material may be an adhesive (e.g., a glue). The waste or scrap material 106 comprising the leather layer 102 may comprise various types of animal based materials, such as leather or skin from cows, sheep, ostrich, alligator, etc. For example, discarded leather scrap may be ground up and reconstituted as the leather layer 102 without having to use a new animal for its hide. In this manner, the shearling 100 detailed herein is a sustainable, animal friendly, and environmentally friendly product.

The knitted wool layer 104 is attached to a first side/surface of the leather layer 102 and, in the illustrated example, the knitted wool layer 104 is provided on a side of the leather layer 102 on which the backing layer 108 is provided. The knitted wool layer 104 is attachable to the leather layer 102 via various means, for example, such as an adhesive. The leather layer 102 also includes an exposed side/surface 110 that is provided opposite the knitted wool layer 104 (and opposite the backing layer 108). Where the shearling 100 is ultimately made into an article of clothing or footwear, the exposed side 110 of the shearling 100 may be exposed to the elements (and visible to third parties), whereas the knitted wool layer 104 may be oriented towards the wearer of the article. Thus, a texture or design may be provided on the exposed surface 110 of the shearling 100, such that the shearling 100 appears to be naturally occurring product (i.e., directly from an animal), rather than being a processed or manufactured material, albeit a processed or manufactured material made from natural and authentic materials rather than synthetic/fake materials.

In some examples, the exposed surface 110 of the shearling 100 is texturized (i.e., subject to texturizing process) whereby the exposed surface 110 is provided with particular feel (e.g., a suede feel, or a leather feel, etc.). For example, the exposed surface 110 may be texturized by working or softening the recycled leather layer 102 to make the surface softer like the suede of natural shearling. In some examples, the exposed surface 110 may be texturized mechanically, for example, via utilization of release paper, buffing, and/or brushing. With a release paper application, an adhesive type tape is applied to the exposed surface 110 and then the release paper is pulled off, which thereby provides a brushed or texturized effect. With mechanical buffing or brushing, the fibers are upward and give the desired effect. In some examples, both release paper and buffing/brushing may be utilized. In some examples, the exposed surface 110 of the shearling 100 is texturized by laminating another layer of material thereon. For example, a micro-fiber material/layer (not illustrated) may be limited on the exposed surface 110, whereby the micro-fiber material/layer may simulate the feel of a natural shearling suede surface. Where utilized, such additional layer(s) of material may have additional characteristics that may be desirable to the end-user wearing the article, such as weather, water, or wind resistance capabilities. Thus, an exposed side of the shearling material 100 that is provided opposite the wool layer 104 may be provided with a certain feel, texture, and/or color, as may be desirable, and such characteristics are highly controllable in contrast to a shearling obtained directly from an animal. Moreover, the leather layer 102 of the shearling 100 may be free of visible blemishes, imperfections, discolorations, etc. that may otherwise be present with a natural animal pelt/skin. Accordingly, it is possible to control the feel, aesthetics, and/or functionality, etc. of the surface 110 of the leather layer 102 as may be desirable based on the end use of the shearling material 100.

The knitted wool layer 104 may comprise recycled clippings 112 (e.g., wool clippings) organized together to simulate the fur surface of natural shearling material directly from an animal. The knitted wool layer 104 may be loose fibers which are knitted into the backing layer 108, thereby becoming a unitary layer, and then that combined unitary layer is then adhered to the leather layer 106 via an adhesive or may be pressed/laminated. In some embodiments, the clippings 112 may be combined with one or more additional materials or fillers (e.g., fur, cotton, polyester, Tencel, silk, etc.) at various blends (e.g., 80/20 blend of wool and Tencel). By blending in one or more filler materials into the clippings 112 of the knitted wool layer 104, it will be possible to more precisely control the feel, aesthetics, and/or functionality, etc. of the knitted wool layer 104. In this manner, the knitted wool layer 104 of the shearling 100 may be free of blemishes, imperfections, discolorations, etc. that may otherwise be present with a natural animal pelt/skin. Furs, hair, or other materials other may be utilized instead of the recycled wool clippings 112. For example, recycled alpaca hair clippings may be utilized instead of wool clippings 112, and in such embodiments, the surface 110 of the recycled leather layer 102 may be texturized to have a feel and appearance that simulates natural alpaca skin such that the manufactured material 100 simulates a natural alpaca hide/pelt.

In some examples, a second knitted wool layer (not illustrated) may be provided opposite from the first knitted wool layer 104. In this manner, the shearling 100 may be provided with wool/fur on both sides. The second knitted wool layer may be attached to the underlying leather layer (and/or backing layer) in a manner as described above with regards to the first knitted wool layer 104.

As described above, the manufactured shearling material 100 is highly controllable and can be manufactured without blemishes/imperfections that are otherwise present on naturally occurring shearling (i.e., on an animal pelt/hide). Also, the manufactured shearling material 100 described herein may be provided or formed as a sheet (or roll) of material, which allows utilization of gang cutting techniques and allows cutting multiple layers at a time, thereby improving handling and processing efficiencies and reducing waste. In an example where the manufactured shearling material 100 is utilized to construct a garment or wearable product (e.g., a slipper), one or more slipper patterns may be cut from one or more layers of the manufactured shearling material 100, and then the slipper pattern may be attached to an outsole. The outsoles may be comprised of various types of materials, including sustainable materials (e.g., recycled EVA including other elements such as algae).

In this manner, the shearling 100 is made from real and natural leather and wool/fur/hair of a particular animal, as opposed from a synthetic or fake leather and/or wool/fur/hair, but the presently disclosed shearling 100 is a manufactured product from recycled materials and thus more sustainable than a shearling obtained directly from the particular animal (e.g., sheep).

A limitation of working with real leather is that it does not come in rolls or sheets, but instead comes in sizes based on the animal from which it was taken, which may be awkward in size and shape resulting in material waste. A benefit of working with synthetic and fake shearling materials is that they may be produced in rolls in sheets, which are easier to work with and to cut from, with minimal waste; however, such synthetic and fake shearling materials may not feel or appear authentic and may not be desirable by many end users, especially those preferring luxury products. Thus, the presently disclosed manufactured shearling material 100 provides the manufacturer with a luxury material from which they can economically produce luxury shearling products from with minimal waste and which will be desirable to the end user. Moreover, the presently disclosed shearling 100 is manufactured from natural shearling materials, such that it may be more authentic or natural than shearlings comprised of synthetic materials.

FIG. 2 is an exploded view of another manufactured shearling material 200, according to one or more embodiments alternate of the present disclosure. In the illustrated example, the leather layer 102 is illustrated detached (or unassembled) from the knitted wool layer 104. Here, the knitted wool layer 104 includes fur/hair/wool fibers or clippings 112 selected based on the type of shearling (i.e., type of animal) to be produced, and which are then knitted onto the backing layer 108. As shown, the backing layer 108 includes a first face on which the clippings 112 are provided, and a second face 114, opposite the first face, for attachment to the leather layer 102.

The leather layer 102 may include the layer of ground/shredded recycled material 106 that is adhered to the face 114 of the backing layer 108 opposite the knitted wool layer 104. In some examples, a binder or binding agent is utilized to hold (secure) the material 106 together, when separated from the knitted wool layer 104 and the backing layer 108, and thereby form a form a separate cohesive leather layer 102 (i.e., of the material 106). Thereafter, the cohesive leather layer 102 is attached to the opposite face 114 of the backing layer 108. In some examples, the adhesive is a glue.

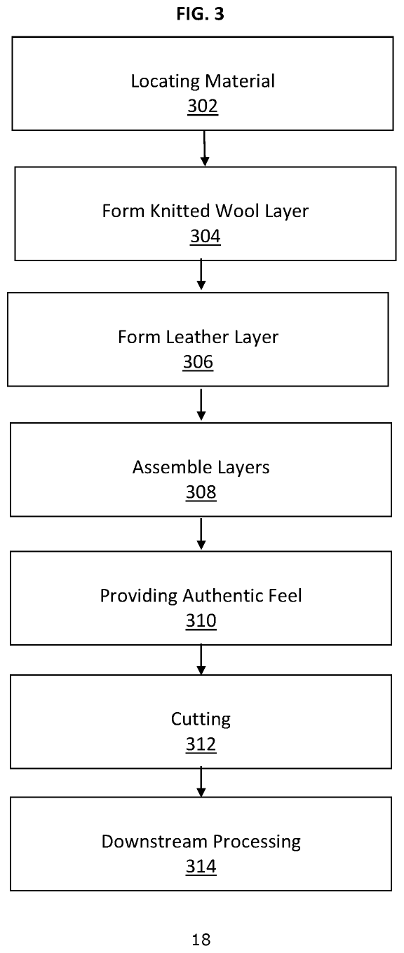

Embodiments of the presently disclosed shearling materials 100, 200 utilize natural shearling materials (e.g., actual leather and wool) which are combined via a manufacture process. Thus, also disclosed herein are methods of manufacturing or producing a manufactured natural shearling, such as the shearling 100 detailed above. FIG. 3 illustrates an exemplary method 300 for manufacturing or producing a manufactured shearling, according to one or more embodiments.

In the illustrated example, the method 300 comprises a first step 302 of obtaining the natural materials to be utilized in producing the shearling. For example, if the manufactured shearling is intended to mimic or be a natural substitute for actual sheepskin shearling, the step 302 may include locating scrap sheep skin/leather (without having to butcher a new animal) and then grind or shred that scrap sheep skin/leather. In this example, the first step 302 would also include locating scrap sheep fur/hair. As will be appreciated, if the manufactured shearling is to be utilized as a substitute for another animal's pelt/hide material, then the scrap leather and fur to be utilized would preferably be from that particular species of animal.

Here, the method 300 also comprises a second step 304 of forming a knitted wool layer, such as the knitted wool layer detailed above. The knitted wool layer may be formed by knitting the fur/hair/wool to a backer layer, such as the backing layer 108 detailed above. For example, wool or a mixture of wool and a synthetic fiber (e.g., Tencel) are utilized to form the knitted layer. In some example, an additive is added to the fiber to impart a certain characteristic or function to the fibers, such as an aloe, a moisture wicking material, a softener, a lanolin, a temperature control solution (i.e., a phase change material, such as Outlast® fibers), etc. Such additive or combination of additives may be applied to the fibers before or after knitting the fibers into the knitted layer. In some examples, the fibers are provide are pre coated or pre-applied with the additive (i.e., such that the fibers are additive enriched before knitting), and then such additive enriched fibers are knitted together into the knitted layer.

Here, the method 300 also comprises a third step 306 of forming a leather layer, such as the leather layer 102 detailed above. The leather layer may be formed by grinding the scrap leather and then forming it as a sheet or roll. In some embodiments, the ground scrap leather is mixed with a binder or adhesive and set in the form of a sheet or roll. In some embodiments, the ground scrap leather is adhered to a backing layer. For example, the scrap leather may be adhered on a side of the backing layer 108 opposite the wool. In this manner, the leather layer may be formed on the knitted wool layer.

However, as detailed herein the knitted wool layer and the leather layer may be formed as separate and discrete layers that are subsequently combined together during a separate step. In the illustrated example, the method 300 may comprise a fourth step 308 of assembling the formed knitted wool layer and the formed leather layer together to yield a sheet (or roll) of manufactured shearling.

Thereafter, the surface of the material may be conditioned, texturized or treated so that it has a particular touch or feel. For example, a side of the manufactured shearling may be provided with a suede feel. This may be accomplished by working or softening the recycled leather layer 102 to make the surface softer like the suede of natural shearling, or by applying another layer of material that already includes that feel. According, the method 300 may comprise a fifth step 310 providing the material with an authentic feel.

Thereafter, the sheet (or roll) of manufactured shearling may be cut to size in different size sheets/rolls. Using such sheets or rolls of manufactured shearling, the manufacturer may utilize gang cutting techniques to obtain the raw material patterns/templates as may be desirable based on the article to be manufactured (e.g., clothing or footwear). Thus, the method 300 may comprise a sixth step 312 of cutting one or more patterns from the manufactured shearling.

Further downstream processing of the manufactured shearling templates may be needed or desirable depending on the article to be made form the shearling. For example, one or more of the patterns may be attached together to form an article, and/or a rubber sole may be attached, etc. Thus, the method 300 may comprise a seventh step 314 comprising further downstream processing.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A shearling material, comprising:
recycled leather particles formed together to define a cohesive leather layer having a first surface and a second surface opposite the first surface; and
a layer of knitted wool provided on the first surface.

2. The shearling material of claim 1, wherein the layer of knitted wool includes a plurality of wool clippings knitted to a backing layer.

3. The shearling material of claim 2, wherein the wool clippings extend from a first side of the backing layer and the backing layer includes a second side opposite the first side, and wherein a face of the cohesive leather layer is adhered to the second side of the backing layer after the wool clippings have been knitted thereon.

4. The shearling material of claim 2, wherein the wool clippings extend from a first side of the backing layer and the backing layer includes a second side opposite the first side, and wherein the recycled leather particles are provided on the opposite first side of the backing layer and secured together on the backing layer via a binder.

5. The shearling material of claim 2, wherein the wool clippings extend from a first side of the backing layer and the backing layer includes a second side opposite the first side attachable to a face of the cohesive leather layer, the cohesive leather layer having an exposed surface opposite the knitted wool layer that is texturized or worked to have a natural feel.

6. The shearling material of claim 2, wherein the wool clippings extend from a first side of the backing layer and the backing layer includes a second side opposite the first side attachable to a face of the cohesive leather layer, the cohesive leather layer having an exposed surface on which an outer layer is provided, the outer layer having an outer surface that is texturized or worked to have a natural feel.

7. The shearling material of claim 1, wherein the recycled leather particles are provided on a backing layer and secured together on the backing layer via a binder, thereby defining the cohesive leather layer.

8. The shearling material of claim 7, wherein the layer of knitted wool includes a plurality of wool clippings knitted to the cohesive leather layer.

9. The shearling material of claim 8, wherein the wool clippings extend from a side of the backing layer opposite from the recycled leather particles.

10. The shearling material of claim 9, wherein a side of the cohesive leather layer opposite from the backing layer is texturized or worked to have a natural feel.

11. The shearling material of claim 8, wherein the wool clippings extend from a side of the cohesive leather layer opposite from the backing layer.

12. The shearling material of claim 11, wherein an exposed surface of the backing layer is texturized or worked to have a natural feel.

13. The shearling material of claim 11, wherein an outer layer is provided on an exposed surface of the backing layer, the outer layer having an outer surface that is texturized or worked to have a natural feel.

14. A method for producing a manufactured natural shearling, comprising:
forming a cohesive leather layer; and
knitting wool clippings to the cohesive leather layer.

15. The method of claim 14, wherein forming a cohesive leather layer includes grinding leather into a particulate.

16. A method for producing a manufactured natural shearling, comprising:
forming a knitted wool layer by knitting any one or more of fur, wool, hair, or synthetic fiber onto a backer layer and extending from a first side thereof;
grinding scrap leather;
forming, from the ground scrap leather, a cohesive leather layer having the form of a sheet or roll; and
adhering the cohesive leather layer to the knitted wool layer.

17. The method of claim 16, wherein forming the cohesive leather layer comprises adhering the cohesive leather layer to a second side of the backer layer opposite the first side.

18. The method of claim 16, wherein knitted wool layer and the cohesive leather layer are formed as separate and discrete layers that are subsequently combined together during a separate step.

19. The method of claim 16, further comprising conditioning, texturizing or treating a first side of the cohesive leather layer to achieve a suede touch or feel.

20. The method of claim 19, wherein said conditioning, texturizing or treating comprises applying another layer of material.

21. The method of claim 16, wherein the manufactured natural shearling is formed as a sheet or roll.

22. The method of claim 21, further comprising gang cutting the sheet or roll of manufactured natural shearling.

23. The method of claim 16, wherein the backing layer a polyester non-woven material or other type of fabric, or recycled leather.

24. The shearling material of claim 2, wherein the backing layer a polyester non-woven material or other type of fabric, or recycled leather.
